(19) United States
(12) Patent Application Publication
(10) Pub. No.: US 2016/0338265 A1
(43) Pub. Date: Nov. 24, 2016

(54) Dual discharge deck for a lawnmower

(71) Applicant: Angela Starner, Westbrook, MN (US)

(72) Inventor: Angela Starner, Westbrook, MN (US)

(21) Appl. No.: 14/720,408

(22) Filed: May 22, 2015

(51) Int. Cl. A01D 34/71; A01D 34/64

(52) U.S. Cl. CPC A01D 34/71; A01D 34/64

(57) ABSTRACT

A dual discharge deck for a lawn mower discharges cut grass in the direction chosen by the user. The discharge may be quickly and easily shifted from one side of the deck to the other, preferably while the mower is in motion. A lever or other mechanical or electronic control actuates the shifting of the cutting discharge.

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to lawn care equipment and accessories, and in particular to a dual discharge deck for a lawn mower. For those homeowners with large lawns, a lawn mower has become indispensable. Unfortunately, the device as designed is very cumbersome, and incapable of directing the discharge of grass clippings in more than one direction. Thus the user has two choices: either the grass clippings might be discharged into a swimming pool, into the street, against a white picket fence, or to some other location which is very inconvenient, or the user must back up the mower and turn it around frequently, making the task of mowing the lawn more annoying and time-consuming. A dual discharge deck for a lawn mower, which will discharge grass clippings to either side of the mower, would resolve this problem.

### SUMMARY OF THE INVENTION

Accordingly, the invention is directed to a dual discharge deck for a lawn mower. The cutting discharge may be quickly and easily shifted from one side of the deck to the other, preferably while the mower is in motion. A lever or other mechanical or electronic control actuates the shifting of the cutting discharge.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a right side perspective view of the first exemplary embodiment mounted on a lawn mower 20, displaying the deck 10, the lever 11, the right discharge chute 12, and the mower 16.

FIG. 2 is a left side perspective view of the first exemplary embodiment mounted on a lawn mower, displaying the deck 10, the left discharge chute 13, and the mower 16.

FIG. 3 is a bottom view of the first exemplary embodiment mounted on a lawn mower, displaying the deck 10, the right discharge chute 12, the left discharge chute 13, the blade 14, the diverter 15, the mower 16, and the interior surface 17.

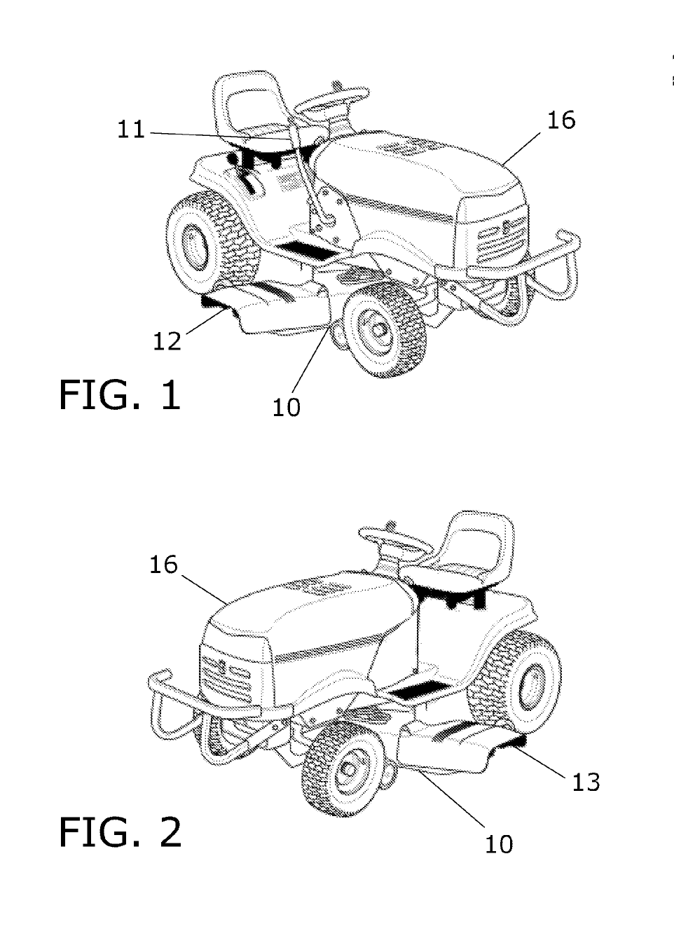

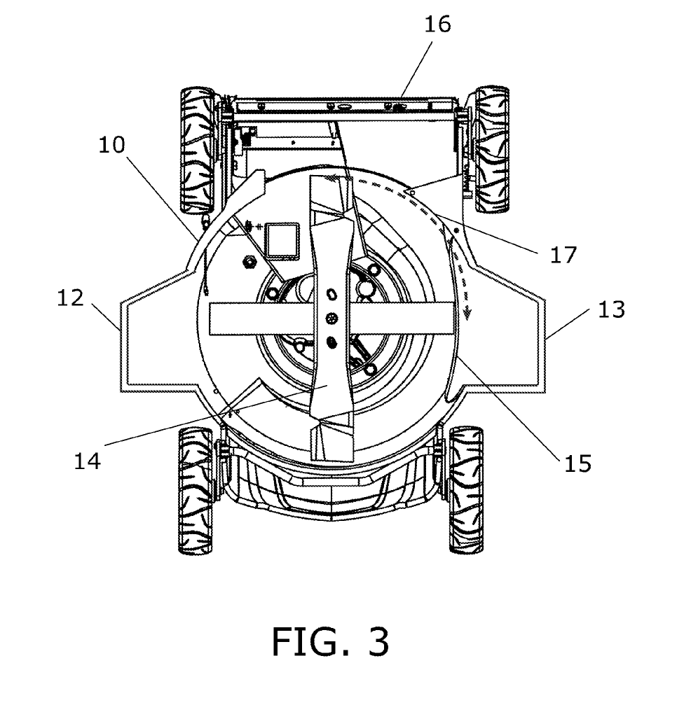

### DETAILED DESCRIPTION OF THE INVENTION

Referring now to the invention in more detail, the invention is directed to dual discharge deck 10 for a lawn mower 16. The cutting discharge may be quickly and easily shifted from one side of the deck 10 to the other, preferably while the mower 16 is in motion. A diverter control lever 11 or other mechanical or electronic diverter control actuates the shifting of the cutting discharge.

The first exemplary embodiment is intended for installation on a riding lawn mower 16 as original equipment by the manufacturer of the mower 16. An alternate embodiment, which is capable of being installed on a riding lawn mower by the user or a mower repair shop as an after-market modification, is also contemplated. Other alternate embodiments, which are intended for installation on a push mower by the manufacturer of the mower, are also contemplated.

The first exemplary embodiment comprises a riding lawn mower 16 with a mower deck 10, providing a diverter control lever 11 within easy reach of the driver's seat. Preferably, the lever mechanically operates a diverter 15 which easily rotates along the interior surface of the deck 10, to block either the right discharge chute 12, or the left discharge chute 13. The lever 11 provides an arrow or other indicator to inform the user where the discharge is currently directed. Preferably, the diverter 15 may be shifted from one side to the other while the mower 16 is in motion and the blade 14 is turning.

To use the first exemplary embodiment, the user mows the lawn with the riding lawn mower 16. The user may operate the lever 11 at any time to change the direction in which the grass clippings are discharged.

The deck 10, the lever 11, right discharge chute 12, the left discharge chute 13, the blade 14, the diverter 15, and the mower 16 are preferably manufactured from rigid, durable materials, such as steel, aluminum alloys, copper alloys, fiberglass, and plastic. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A dual discharge deck for a lawn mower, comprising:
(a) a lawn mower;
(b) said lawn mower comprising a mower deck;
(c) said mower deck comprising a left side, a right side, and an interior surface;
(d) said mower deck further comprising a left discharge chute and a right discharge chute;
(e) said left discharge chute being located on said left side of said mower deck;
(f) said right discharge chute being located on said right side of said mower deck;
(g) a diverter;
(h) said diverter being attached to said interior surface of said mower deck;
(i) said diverter being of a size and shape that conforms to block either said left discharge chute or said right discharge chute;
(j) a diverter control means for controlling said diverter;
(k) said diverter control means for controlling said diverter being configured for actuating the shifting of said diverter.

2. The dual discharge deck for a lawn mower of claim 1 wherein said diverter control means for controlling said diverter is a lever.

3. The dual discharge deck for a lawn mower of claim 2 wherein said lever is mechanically attached to said diverter.

4. The dual discharge deck for a lawn mower of claim 3 wherein said diverter is rotationally urged by said lever.

5. The dual discharge deck for a lawn mower of claim 4 wherein said lever is interlinked with said diverter such that said lever rotates said diverter by rotating back and forth.

6. The dual discharge deck for a lawn mower of claim 2 wherein said lever provides indicia of the location of said diverter.

7. The dual discharge deck for a lawn mower of claim 2 wherein said lever is located within arm's length of a user.

8. The duel discharge deck for a lawn mower of claim 1 wherein said diverter control means for controlling said diverter is an electronic control.

9. The duel discharge deck for a lawn mower of claim 8 wherein said electronic control is electronically connected to a motor.

10. The duel discharge deck for a lawn mower of claim 9 wherein said motor is interlinked with said diverter such that said motor rotates said diverter.
